(19) United States
(12) Patent Application Publication
(10) Pub. No.: US 2024/0036599 A1
(43) Pub. Date: Feb. 1, 2024

(54) SELF-REFERENCING DETECTION OF FIELDS OF 4-F CONVOLUTION LENS SYSTEMS

(71) Applicant: Neurophos LLC, Durham, NC (US)

(72) Inventors: Patrick T. Bowen, Austin, TX (US); Andrew J. Traverso, Durham, NC (US); Daniel Marks, Durham, NC (US); Tom Driscoll, San Diego, CA (US)

(21) Appl. No.: 18/485,912

(22) Filed: Oct. 12, 2023

Related U.S. Application Data
(63) Continuation of application No. PCT/US2022/027521, filed on May 3, 2022.
(60) Provisional application No. 63/183,207, filed on May 3, 2021.

(51) Int. Cl. G06E 1/04; G02B 27/00; G06N 3/067

(52) U.S. Cl. CPC G06E 1/045; G02B 27/0012; G06N 3/0675

(57) ABSTRACT

In an example embodiment, a system is provided to perform a convolution operation via optical fields. The system may include, for example, a Fourier transform lens to compute the Fourier transform of data encoded onto a coherent optical field. The system may also include a spatial light modulator to encode a superimposed object and constant function onto an optical field. The system may also include a spatial light modulator to encode a pattern onto an optical field. The system may also include a detector to detect the optical field that encodes the results of the convolution. In various instances, the detector is configured to detect the intensity of the optical fields encoding the result of convolutions. The first spatial light modulator may vary the phase between the signal and constant functions for each convolution that is encoded onto the field.

### RELATED APPLICATIONS

This application is a continuation of PCT Application No. PCT/US2022/027521 filed on May 3, 2022 titled “Self-Referencing Detection of Fields of 4-F Convolution Lens Systems,” which application claims benefit of and priority to U.S. Provisional Patent Application No. 63/183,207, titled “Self-Referencing Detection of Fields of 4-F Convolution Lens Systems,” filed on May 3, 2021, which applications are hereby incorporated by reference in their entireties.

### TECHNICAL FIELD

This application relates to metamaterial elements, Fourier transforms, machine learning, artificial intelligence, and convolutional neural networks.

### BRIEF DESCRIPTION OF THE DRAWINGS

FIG. 1 illustrates a graphical representation of the complex-valued polarizability of a tuned Lorentzian resonator, according to one embodiment.

FIG. 2A illustrates a standard graphical representation of an example of the complex-valued polarizability of a tuned Lorentzian resonator, according to one embodiment.

FIG. 2B illustrates a simplified graphical representation of an example of the complex-valued polarizability of a tuned Lorentzian resonator, according to one embodiment.

FIGS. 3A and 3B illustrate graphical representations for the identification of a real number that is the difference between two different complex-valued polarizabilities of a Lorentzian resonator tuned using two frequencies, according to one embodiment.

FIGS. 4A and 4B illustrate graphical representations of the real numbers represented by the difference between two complex-valued polarizabilities scaled to represent the available tuning range of a Lorentzian resonator, according to one embodiment.

FIG. 5 illustrates an example block diagram of a four-focal length (4F) convolution system with arrays of Lorentzian resonators used to represent the object and kernel functions, according to one embodiment.

FIG. 6 illustrates an example of a mathematical derivation for calculating the convolution of a real function with a complex kernel with a cosine phase, according to one embodiment.

FIG. 7 illustrates an example of a mathematical derivation for calculating the convolution of a real function with a complex kernel with a sine phase, according to one embodiment.

FIG. 8 illustrates an example of a mathematical derivation for calculating a real function with the difference of two complex kernels, according to one embodiment.

### DETAILED DESCRIPTION

Electronic analog and digital encoding and processing of signals is used for a wide variety of purposes, especially in cases where a limited number of signals are handled, such as in audio, video, or communication channels. As the number of signals increases, the time, the digital storage needs, the power consumption, and the complexity of electronic processing of digital and analog signals increase. Especially in digital processing, the energy and time costs of processing large numbers of signals (e.g., millions, billions, or more) may be impractical, not feasible with existing technologies, and/or cost-prohibitive.

In various embodiments, neural networks are an application of signal processing where millions of signals may be processed in the course of implementing a decision or classification task. Certain types of signal processing may be performed on optical fields, such as convolution, correlation, Fourier transformation, inner products, and matrix multiplication. The time, energy consumption, and complexity of optical computation provide significant advantages to digital signal processing in many instances. In various embodiments, data is encoded onto coherent optical fields and processed using a combination of imaging optics such as lenses, mirrors, gratings, holograms, and spatial light modulators. The signals travel at the speed of light and are all inherently processed simultaneously. The results of the computation are recorded on a photodetector or an array of photodetectors, such as, but not limited to, a CCD (charge-coupled device) or CMOS (complementary metal-oxide semiconductor) array.

The optical computation recorded by the photodetector may be recorded as samples proportional to a photocount at each pixel of the array. The photocount is proportional to the time-integrated intensity of the field at each pixel. For many computations with coherent fields, a phase of the field encodes necessary results of the computation that are not detected by intensity alone. Detection of the phase and amplitude, or equivalently both quadratures of a coherent field, is necessary to characterize the time-integrated intensity of the field at each pixel.

According to various embodiments, a system may utilize interferometry and/or holography to encode the phase into one or more intensity measurements so that the phase may be inferred from these measurements. This approach may, for example, use a characterized reference beam superimposed on the signal so that the intensity measurements record the relative phase between the reference and signal beams.

Using this approach, vibrations or other disturbances may cause a random shift in the relative phase between reference and signal coherent fields, which manifests as an error in the measured phase. The phase varies on the scale of the wavelength of the coherent field radiation, which for visible and infrared light can be one micrometer or less. Accordingly, nanometer-scale vibrations can cause significant phase errors. However, if the reference and signal beams are shifted by a common delay, even if random, this does not change the detected intensity pattern, which is only dependent on their difference.

Accordingly, some of the embodiments described herein utilize a system that introduces the signal in such a way that the reference beam and the signal beam have a common path and the reference beam and signal beam are disturbed in the same way, and therefore, the disturbance has a minimal effect on the measurement.

According to various embodiments, a system may utilize an optical processor that is capable of performing many common linear computations in the form of a four-focal length (4F) optical system along with a modulator, such as a spatial light modulator. A 4F system can, for example, be used to perform a convolution, a correlation, and/or calculate inner products. The 4F system may include a lens or lenses, each of which computes the optical Fourier transform of a signal encoded onto a coherent optical field. The 4F optical processor performs the computation using Fourier transforms by taking advantage of the convolution theorem, which states that the Fourier transform of the convolution of two functions is the multiplicative product of the Fourier transforms of the two respective functions.

According to various embodiments, the system uses the 4F optical processor to encode a signal to be convolved onto a coherent field at an object plane using a modulator, such as a spatial light modulator. The Fourier transform is applied using a lens to the object coherent field placed one focal length away from the lens, and the Fourier transform result is a coherent field that is also one focal length from the lens. The Fourier transform of the convolution kernel to be applied is modulated onto the Fourier transform result of the object coherent field. A lens performs the Fourier transform of the field after modulation by the Fourier transform of the kernel, with the result being encoded onto the coherent field placed at one focal length away from the lens at an image plane. The system may utilize a reference beam to encode the coherent field result onto the detected intensity to detect the coherent field, which is the result of the convolution at the image plane. Again, differences in vibrations or other movements of the reference beam relative to the signal beam may result in errors.

Accordingly, the presently described systems and methods utilize a modified 4F system to encode the coherent field onto the intensity at the detector using a common path for both the reference beam and the signal beam. As described herein, the presently described system exhibits reduced sensitivity in the recorded results due to mechanical vibrations, temperature variations, and other disturbances. Unlike existing architectures, the presently described systems and methods do not require a separate reference beam by applying multiple modulations to the object and/or kernel plane, recording one or more intensity patterns at the detector plane, and then performing arithmetic operations between these patterns to obtain the results of the convolution.

The presently described systems and methods utilize various types of modulations that are available using spatial light modulators, as described below. Some of the systems and methods described herein utilize amplitude modulation of coherent fields, which may be performed using a spatial light modulator, such as transmissive liquid crystal cells, liquid crystal on silicon (LCOS), and digital micromirror devices (DMDs). Accordingly, the presently described systems and methods obtain the coherent field from intensity measurements that differ by amplitude modulations of the spatial light modulators. In some embodiments, the system may utilize spatial light modulators with metamaterial cells. The metamaterial cells may be, for example, resonant dipoles that are described by damped harmonic oscillators with a response that is described by a scaling constant to its polarizability, resonance frequency, and damping bandwidth or linewidth.

The modulation of resonant metamaterial cells is changed by tuning its resonance frequency, which can be achieved by, for example, changes in mechanical dimension(s) (e.g., via a transducer), tuning the anisotropic direction of a liquid crystal medium, and/or by tuning or modifying a tunable element (e.g., by modifying a capacitance). The resulting modulation of the amplitude and phase of the coherent field is not merely described by the modulation of the amplitude and/or phase alone but may also be used to record multiple intensity measurements at the detector that may be used to infer the result of the convolution.

In one example embodiment, a system to perform a convolution operation using optical fields includes an object plane modulator, an optical assembly to implement first and second Fourier transforms, a kernel plane modulator, and an optical detector to detect intensities of the twice-Fourier transformed (e.g., convolved) output optical field. According to various embodiments, the object plane modulator may transmit a coherent optical field encoded with an input object field and a constant field. Successive coherent optical fields generated by the object plan modulator may utilize various phase-shifted variations of the constant field relative to the input object field.

The optical assembly may include a first optical assembly to implement a first optical Fourier transform of the encoded coherent optical field and a second optical assembly to implement a second Fourier transform of the encoded coherent optical field modulated with a kernel pattern to generate an output optical field that includes a convolution of the input object field. Prior to the second Fourier transform, the once-Fourier-transformed optical field may be modulated with the kernel pattern (e.g., an interference pattern) via a kernel plane modulator.

According to various embodiments, the object plane modulator and/or the kernel plane modulator may comprise a spatial light modulator, such as a tunable optical metasurface. In various embodiments, the system may further include a digital processing subsystem to perform at least one arithmetic operation on the detected intensities of the output optical field to generate digital data representing the convolution of the input object field.

The presently described systems and methods may utilize various optical hardware components, lenses, optical detectors, optoelectronic converters, and/or the like. The presently described systems and methods may operate to generate a sequence of coherent optical fields that are each encoded with a superimposed object and a sequentially phase-shifted constant function. For example, the constant function may be phase-shifted with respect to the superimposed object for each successive coherent optical field generated in the sequence of coherent optical fields.

An optical lens system and kernel plane modulator may operate to perform a first Fourier transform of each coherent optical field in the generated sequence of coherent optical fields, encode a second data function onto each of the coherent optical fields of the once-Fourier transformed sequence of coherent optical fields, and then perform a second Fourier transform on each of the sequentially generated optical fields. An optical detection subsystem (e.g., a photodetector or other optoelectronic converter) can be used to measure or otherwise detect the intensity values of each of the convolved optical fields of the sequence of convolved optical fields.

Many existing computing systems, methods, and devices may be used in combination with the presently described systems and methods. Some of the infrastructure that can be used with embodiments disclosed herein is already available, such as general-purpose computers, computer programming tools and techniques, digital storage media, and communication links. A computing device or controller may include a processor, such as a microprocessor, a microcontroller, logic circuitry, or the like. Various technologies, systems, architectures, and applications are relevant to the presently described embodiments. Examples of such technologies, systems, architectures, and applications include, but are not limited to, certain aspects of deep neural networks, image recognition, recommender systems, medical diagnosis, language processing, and the like.

A processor may include a special-purpose processing device, such as application-specific integrated circuits (ASIC), programmable array logic (PAL), programmable logic array (PLA), a programmable logic device (PLD), field programmable gate array (FPGA), or another customizable and/or programmable device. The computing device may also include a machine-readable storage device, such as non-volatile memory, static RAM, dynamic RAM, ROM, CD-ROM, disk, flash memory, or other machine-readable storage medium. Various aspects of certain embodiments may be implemented using hardware, software, firmware, or a combination thereof.

The components of the disclosed embodiments, as generally described and illustrated in the figures herein, could be arranged and designed in a wide variety of different configurations. Furthermore, the features, structures, and operations associated with one embodiment may be applicable to or combined with the features, structures, or operations described in conjunction with another embodiment. In many instances, well-known structures, materials, or operations are not shown or described in detail to avoid obscuring aspects of this disclosure.

Various embodiments of the systems and methods described herein include an optical convolution processor implemented with a 4F optical system. The optical convolution processor reconstructs the results of a real-valued convolution from a series of intensity measurements at the image plane, where each intensity measurement has a different modulation on the object and/or kernel plane. The system may then perform an electronic computation to compute the results of the convolution. The electronic computation is much simpler than would normally be required to compute a convolution. Specifically, the system may use the 4F optical system to capture the real-valued convolution from a series of intensity measurements at the image plane. Subsequently, the system may use electronic computation to perform the final addition and/or subtraction computations with simple integer ratio divisors to obtain the convolution result.

A 4F convolution system with no restrictions on the amplitude and phase of an object function f(x, y) and a kernel function h(x, y) results in a convolution function g(x, y) as provided by Equation 1 below:

g(x, y)=∫_{-∞}^{∞}∫_{-∞}^{∞}f(x′, y′)h(x−x′, y−y′)dx′dy′ Equation 1

Equation 1 is denoted by the notation g(x, y)=f(x, y)*h(x, y). The 4F convolution system operates according to Equation 1 when the focal length of the lens that performs the Fourier transform from object to kernel plane, and the focal length of the lens that performs the Fourier transform from the kernel to the image plane are the same. If they are not the same, then the result includes a magnification change that can be compensated for using a scalar value. The spatial frequency on the kernel plane scales is represented by width λf₁, where λ is the wavelength of the coherent field, and f₁ is the focal length of the lens between the object and the kernel plane. A second scaling of the spatial frequency is λf₂, where f₂ is the focal length between the kernel and image plane. Accordingly, the overall magnification of the system is −f₂/f₁.

In Equation 1, f(x, y) can be split into two components as follows:

f(x, y; ϕ)=f₀+f′(x, y)exp(iϕ) Equation 2

In Equation 2, f₀ is a constant, and ϕ is a phase that may be varied by adding the function to be convolved to a constant value. The system may achieve the separation and control of these two components via the object spatial light modulator by adding the function to be convolved to a constant value, with a phase shift therebetween. Substituting Equation 2 into Equation 1 gives the following:

g(x, y; ϕ)=[f₀+f′(x, y)exp(iϕ)]*h(x, y) Equation 3
or

g(x, y; ϕ)=f₀h(x, y) +f′(x, y)exp(iϕ) *h(x, y) Equation 3.1

The convolution of a constant function with a non-constant function is a constant function such that g₀ can be denoted as: g₀=f₀*h(x, y). The intensity detected at the image plane is proportional to the magnitude squared of I(x, y; ϕ)=|g(x, y; ϕ)|², such that the intensity can be expressed as:

I(x, y; ϕ)==|g₀|²+|f′(x, y)*h(x, y)|²+2Re{g₀*exp(iϕ)[f′(x, y)*h(x, y)]} Equation 4
or

I(x, y; ϕ)==|g₀|²+g(x, y)|²+2Re{g₀*exp(iϕ)[g(x, y)]} Equation 4.1

The results of the convolution g(x, y) can be recovered using three or four measurements of intensity, I(x, y; ϕ). For example, if three measurements of intensity I(x, y; ϕ)) for ϕ=0,

$$ϕ = \frac{2 π}{3} , and ϕ = - \frac{2 π}{3}$$

are acquired, then:

$$g ( x , y ) = \frac{I ( x , y ; 0 ) + \frac{- 1 - \sqrt{3} i}{2} I ( x , y ; \frac{2 π}{3} ) + \frac{- 1 - \sqrt{3} i}{2} I ( x , y ; - \frac{2 π}{3} )}{\sqrt{3} {g}_{0}^{*}} \qquad Equation 5$$

As another example, if four measurements of intensity (x, y; ϕ)) for ϕ=0,

$$ϕ = \frac{π}{2} , ϕ = π , and ϕ = - \frac{π}{2}$$

are acquired, then:

$$g ( x , y ) = \frac{I ( x , y ; 0 ) + I ( x , y ; \frac{π}{2} ) - I ( x , y ; π ) - iI ( x , y ; - \frac{π}{2} )}{2 {g}_{0}^{*}} \qquad Equation 6$$

The intensity measurements used in Equations 5 and 6 rely on both varying phase and amplitude being encoded onto the object spatial light modulator function f(x, y). However, when both f(x, y) and h(x, y) are real-valued, their convolution g(x, y) is real-valued as well. In this case, the system need only encode with two phases ϕ=0and ϕ=π, such that:

$$g ( x , y ) = \frac{I ( x , y ; 0 ) - I ( x , y ; π )}{2 {g}_{0}^{*}} \qquad Equation 7$$

These two modulations use the object plane modulations f(x, y; 0) and f(x, y; π), which are real-valued. Furthermore, the constant field f₀ may be chosen to be large enough so that there are no negative real values that need to be encoded onto the modulator. The relatively large field on the object plane can be mathematically represented by an amplitude-only modulator. Using an amplitude-only modulator in the object plane to compute a real-valued convolution avoids a separate reference beam. Furthermore, the calculations of Equation 7 involve only subtraction and a division by 2 (up to a constant), which may be performed with low energy and time cost using electronic hardware to generate digital samples.

In some embodiments, the system utilizes metamaterial elements to scatter optical radiation with a combination of amplitude and phase modulations that may be modeled as a damped harmonic oscillator dipole. The resonance frequency of the modeled damped harmonic oscillator dipole is used to tune each element. A dipole that is a damped harmonic oscillator is referred to as Lorentzian.

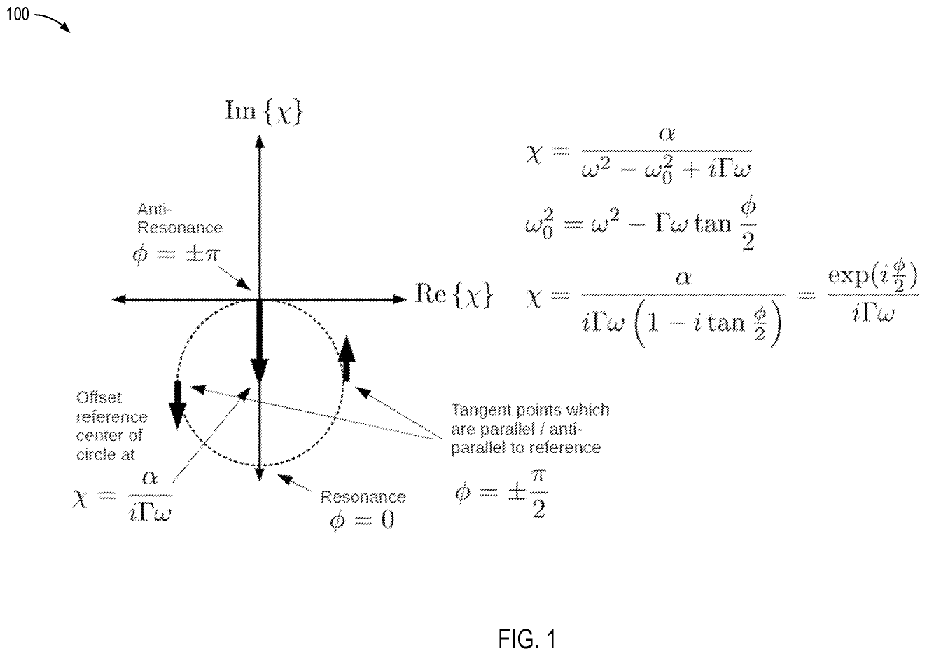

FIG. 1 illustrates a graphical representation 100 of the complex-valued polarizability (dashed line) of a tuned Lorentzian resonator, according to one embodiment. Specifically, the graphical representation illustrates the available complex-valued polarizability, x, with a tuned resonance frequency, ω₀, a damping bandwidth, Γ, a frequency of coherent radiation ω, and a constant of proportionality, α, which scales the overall scattering. Each point on the complex plane corresponds to the polarizability, x, at a given tuned resonance frequency. The polarizability starts at x=0 when the resonance frequency is far below the field frequency (ω₀<<ω). The polarizability is x=α/iΓω at resonance when the resonance frequency is equal to the field frequency (ω₀=ω). The polarizability returns to x=0 when the resonance frequency is far above the field frequency (ω₀>>ω). The path the polarizability, x, traces in the complex plane is a circle tangent to the origin with a center of x=α/iΓω and a radius of α/iΓω.

The illustrated circle can also be parameterized by an angle ϕ, between −π and π, (−π<ϕ<π). As such, the circle may be alternatively traced over the domain of ϕ, and the Lorentzian dipole can be regarded as a fixed dipole of polarizability

$$\frac{α}{i ⌈ ω}$$

with a dipole of arbitrary phase of amplitude

$$\frac{α}{i ⌈ ω}$$

and its phase given by ϕ. Therefore, a Lorentzian dipole can be regarded as a phase-modulating element with a fixed scattering dipole offset. The fixed offset may be modified by other fixed scattering structures near the dipole as well as the dipole itself.

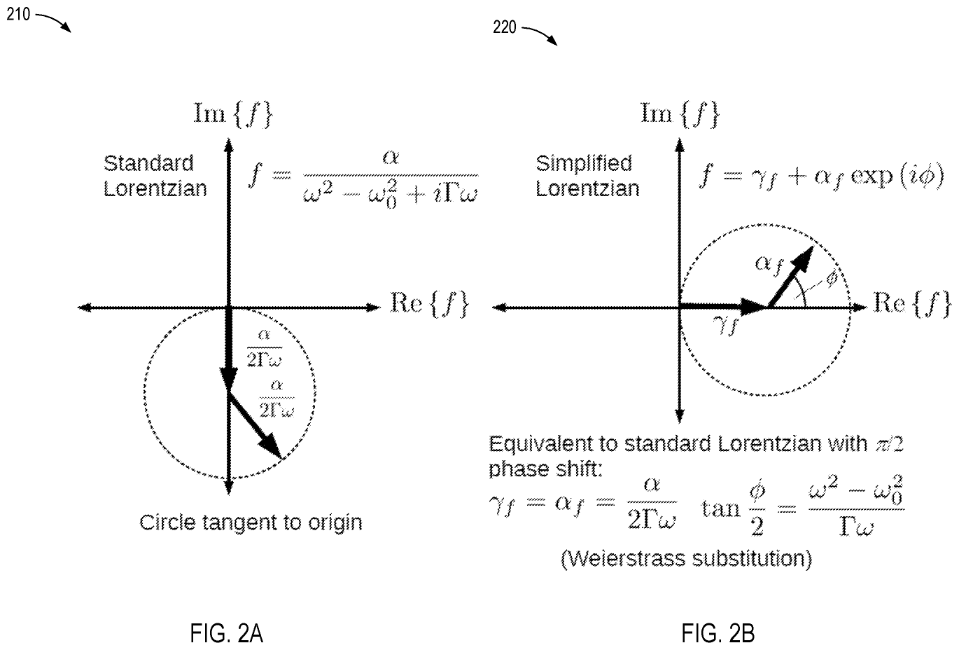

FIG. 2A illustrates a standard graphical representation 210 of an example of the complex-valued polarizability of a tuned Lorentzian resonator, according to one embodiment. As illustrated, a target scattering angle is achieved by a selected resonance frequency. With generality, the complex-value polarizability may be rotated by

$$\frac{π}{2}$$

radians in the complex plane to impart a fixed scattering amplitude that would be common to all dipoles. The polarizability of the Lorentzian resonator as a function of resonant frequency is given by:

$$f = \frac{i α}{{ω}^{2} - {ω}_{0}^{2} + i ⌈ ω} \qquad Equation 8$$

FIG. 2B illustrates a simplified graphical representation 220 of an example of the complex-valued polarizability of a tuned Lorentzian resonator, according to one embodiment. In FIG. 2B, the polarizability of the Lorentzian resonator is expressed as a sum of a fixed dipole and an arbitrary dipole with a fixed magnitude, such that:

f=γ_{f}+α_{f} exp(iϕ) Equation 9

Using Equations 8 and 9 with

$${γ}_{f} = {α}_{f} = \frac{α}{i ⌈ ω} ,$$

the phase ϕ can be found as:

$$tan \frac{ϕ}{2} = \frac{{ω}^{2} - {ω}_{0}^{2}}{⌈ ω} \qquad Equation 10$$

Using Equation 10, a frequency ω is selected so that the varying part of the dipole has a target phase ϕ (e.g., using a Weierstrass substitution). The parameterization of the circle allows for the simplification of the associated trigonometric integrals. Again with reference to Equation 10, a metamaterial element may be tuned to a resonance frequency that corresponds to a target phase angle. Furthermore, this correspondence is made when measurements are made of the intensity at the image plane of a 4F system with a metamaterial element tuned to a phase.

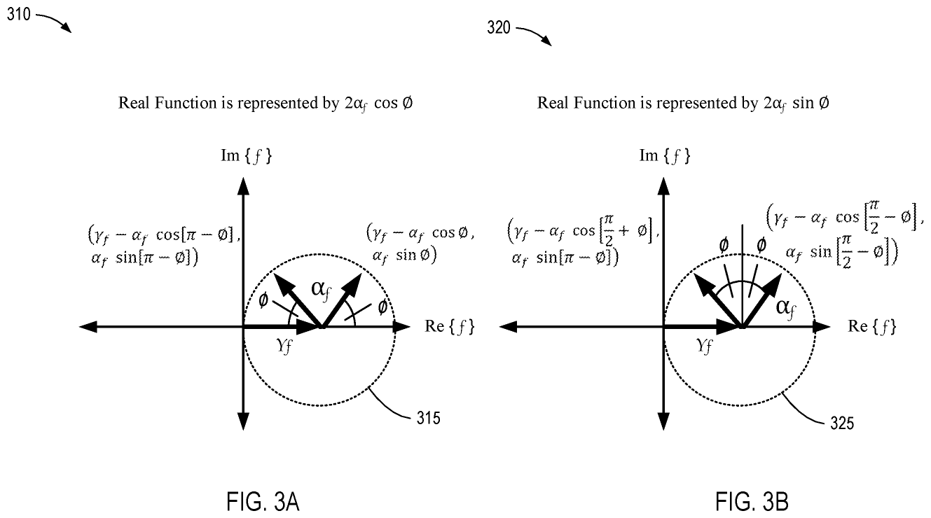

FIGS. 3A and 3B illustrate graphical representations 310 and 320 for the identification of a real number that is the difference between two different complex-valued polarizabilities of a Lorentzian resonator tuned using two frequencies, according to one embodiment. As noted above, metamaterial resonators in the system may be tuned to a particular frequency to attain a target polarizability, not including the fixed offset. As such, the system may realize a real-valued dipole using the cancellation of the scattering of two metamaterial dipoles, as shown in the example graphical representations 310 and 320.

In FIG. 3A, two arrows pointing to the circle perimeter represent the net polarizability of two metamaterial dipoles, one of which is tuned to an angle ϕ and the other π−ϕ. By subtracting the first polarizability from the second polarizability, a real-valued polarizability of 2αf cos ϕ is attained.

FIG. 3B illustrates a similar result attained using a phase ϕ referenced to the imaginary axis rather than the real axis. Accordingly, the system may utilize two measurements of the coherent field at the image plane, including a first measurement with a metamaterial resonator being at a phase ϕ and a second measurement with a metamaterial resonator being at a phase π−ϕ. In embodiments utilizing this approach, the system subtracts these two measurements to obtain the same result that would have otherwise been attainable by directly tuning the real-valued polarizability 2αf cos ϕ on the resonator (which may not be possible or easily done). As such, the systems and methods described herein utilize tuned metamaterial elements and leverage the equations and relationships above that demonstrate that the convolution of real-valued functions can be effectively synthesized using differences of measurements of the field from Lorentzian dipoles.

In some embodiments, metamaterial resonators may be used that have a limited tuning range. Such metamaterial resonators may not be able to address the entire circle or half-circle needed to attain all real values needed. In such embodiments, the range of real values may be scaled down so that the corresponding angles and resonance frequency are within the available tuning range.

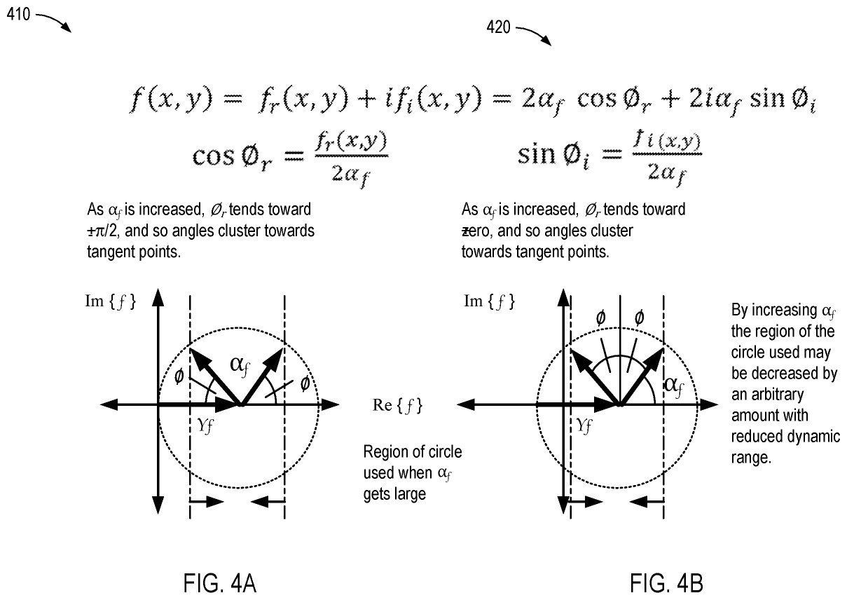

FIGS. 4A and 4B illustrate graphical representations 410 and 420 of the real numbers represented by the difference between two complex-valued polarizabilities scaled to represent the available tuning range of a Lorentzian resonator, according to one embodiment.

FIG. 4A includes two arrows pointing to the perimeter of the circle of complex polarizability for all possible tuning frequencies. However, the resonator (e.g., metamaterial element) used in a particular embodiment may only be tunable within a limited frequency range, as given by vertical dashed lines. The real-valued function may be scaled to fit between these two lines and, therefore, correspond to achievable real-values of the polarizability. In such embodiments, as illustrated in FIG. 4B, the dynamic range of the measurement is reduced because the variation of the field due to the modulation of the resonance frequency is reduced as compared to its fixed component. As the fraction of the signal corresponding to the modulated component is reduced, the number of signal photons is likewise reduced, but the fixed background remains the same so that the photon noise remains the same, and so the signal-to-noise ratio correspondingly decreases. Accordingly, the system may be configured to utilize the full available tuning range (e.g., limited to the actual tuning range) of the metamaterial resonator element to represent the range of real values required and, therefore, obtain the highest signal-to-noise ratio.

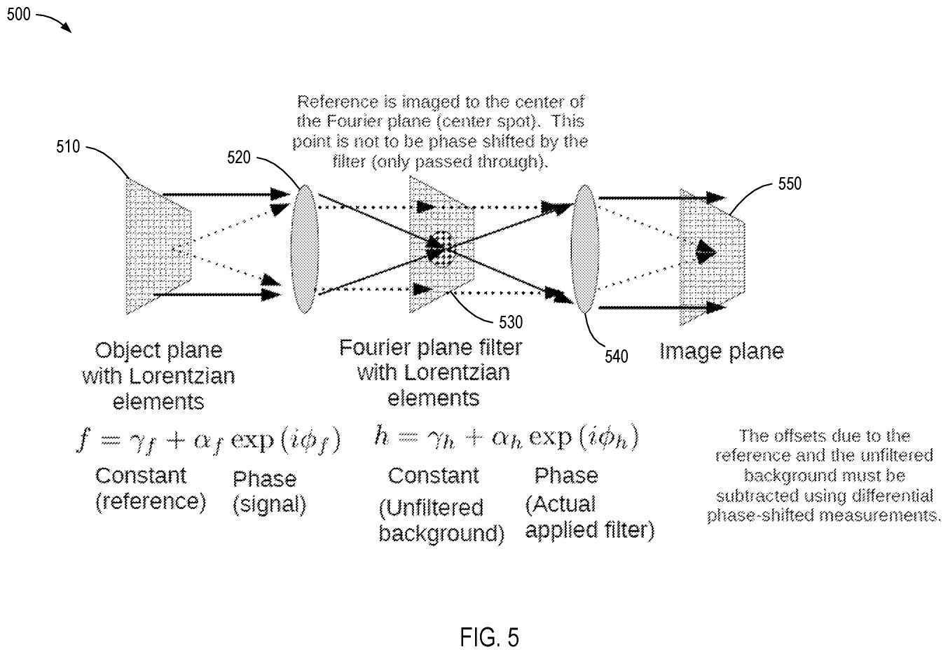

FIG. 5 illustrates an example block diagram of a four-focal length (4F) convolution system 500 with arrays of Lorentzian resonators used to represent the object function of an object metamaterial modulator 510 and kernel function of a Fourier plane filter 530, according to one embodiment. Dashed arrows represent the real image formed on an image plane 550 by optical elements 540 (e.g., one or more lenses), and solid arrows represent a Fourier transform of the image on the image plane 550.

For a given measurement, a complex polarizability of the object metamaterial modulator 510 at an object plane is f(x, y)=γ_{f}+α_{f} exp(iϕ_{f(x, y)}), where γ_{f} is the constant (reference beam) and α_{f} exp(iϕ_{f(x, y)} is the phase (signal). The reference beam is imaged via optical lens assembly 520 (which may include one or more lenses) to the center of the Fourier plane filter 530. The Fourier plane filter 530 passes the reference beam through a center spot without phase shifting the reference. As illustrated, the Fourier plane filter 530 implements a kernel function of h(x, y)=γₕ+αₕ exp(iϕ_{f(x, y)}).

The constant part of the polarizability, γ_{f}, of the object metamaterial modulator 510 at the object plane images (e.g., is deflected, refracted, reflected, etc.) to the center of the kernel plane as denoted by the solid arrows in FIG. 5. The constant field on the image plane 550 component corresponds to α_{f} is the component g₀ in Equations 4, 4.1, and 7, and provides the common-path reference beam. If the constant field is removed from the convolution, for example, by absorbing the optical radiation at the center of the kernel plane, this constant field component would not be available as a reference beam superimposed on the detected signal.

According to various embodiments, the system 500 includes the Fourier plane filter 530 with Lorentzian elements at the kernel plane that preserves the constant field as a reference beam transmitted through the center of the kernel plane without phase shift. Alternatively, the Lorentzian filter-based Fourier plane filter 530 may apply a phase shift to the reference beam that passes through the center of the kernel plane to modulate an interference pattern.

As described herein, the system 500 may utilize metamaterial resonators (e.g., metamaterial resonator elements) to perform real convolutions using or based on the mathematical derivations for convolution provided below, including all derivatives and equivalences thereof. The convolution of a real-valued function f(x, y) is the difference of two Lorentzian polarizabilities with a function h(x, y), which is given to be real-valued. The system 500 synthesizes the real value of f(x, y) from two intensity measurements taken at the image plane 550 with each metamaterial element modulated at one of two phases.

The system identifies a phase function ϕᵣ(x, y) where f(x, y)=2α_{f} Cos ϕᵣ(x, y). The system captures the two intensity measurements when a given metamaterial element at position x, y is modulated at the phase ϕᵣ(x, y) and π−ϕᵣ(x, y) . The system 500 calculates a difference between the two intensity measurements (e.g., via subtraction), where the calculated difference is proportional to the convolution of f(x, y) and h(x, y).

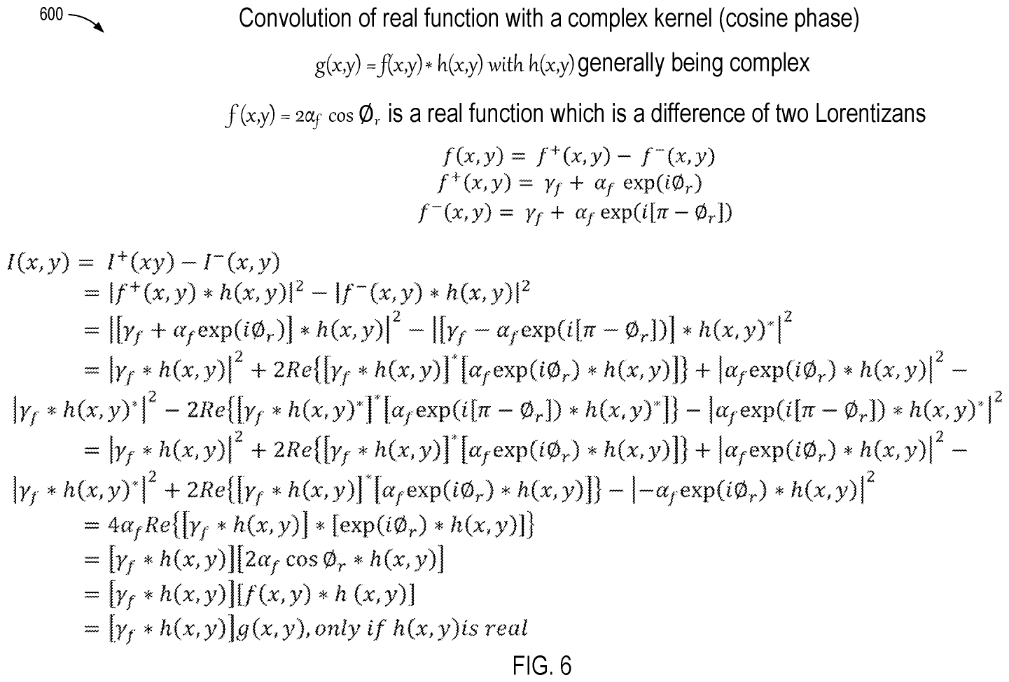

FIG. 6 illustrates an example mathematical derivation 600 that may be used by the system of FIG. 5, in some embodiments, to calculate the convolution of a real function with a complex kernel with a cosine phase, according to one embodiment.

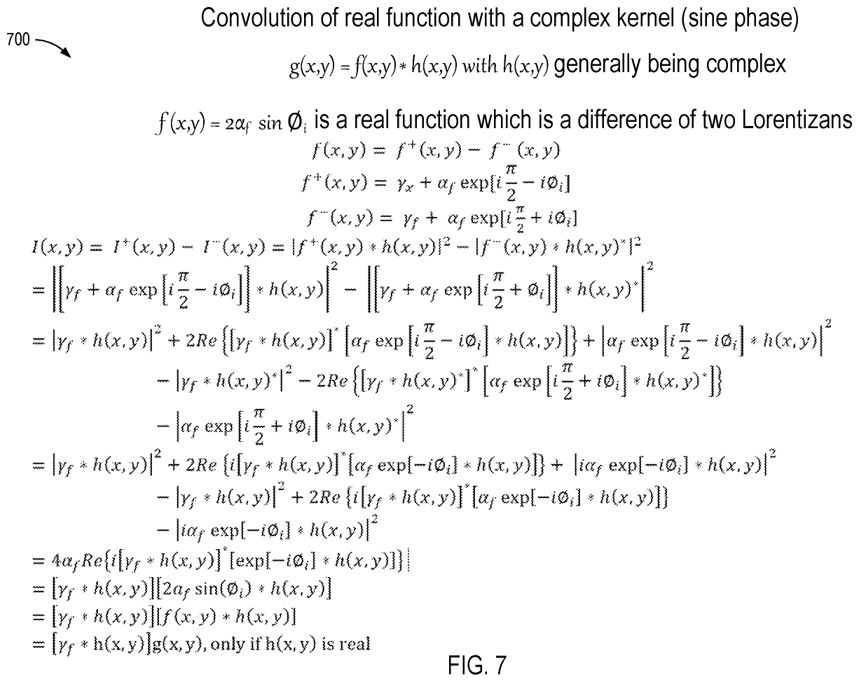

FIG. 7 illustrates another example mathematical derivation 700 that may be used by the system of FIG. 5, in some embodiments, to calculate the convolution of a real function with a complex kernel with a sine phase.

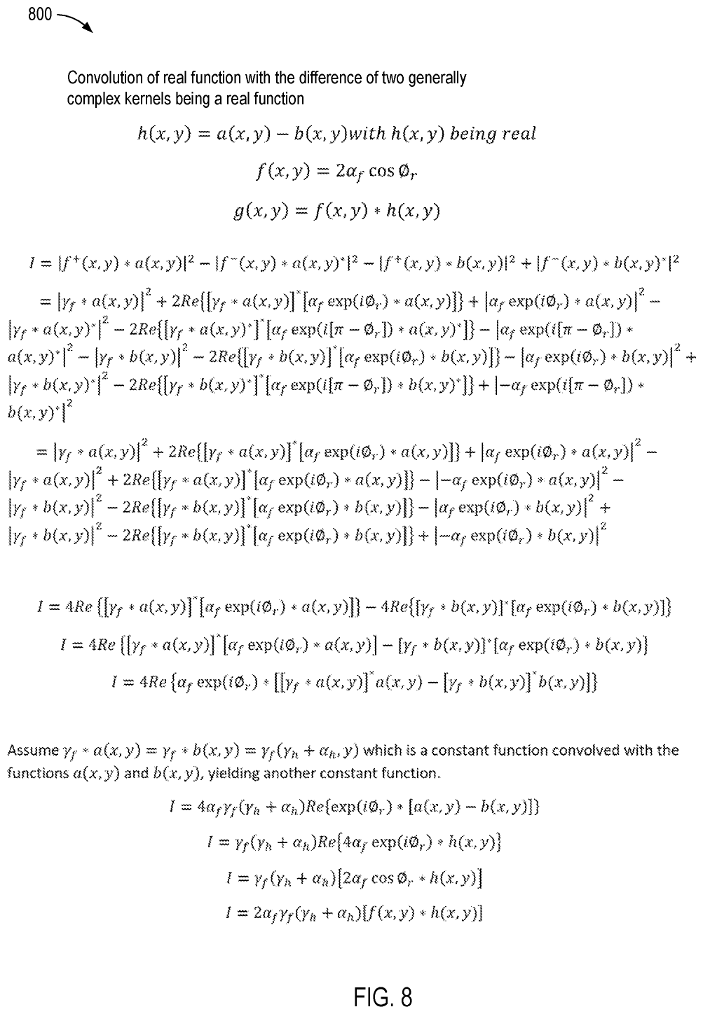

FIG. 8 illustrates an example mathematical derivation 800 for calculating a real function with the difference of two complex kernels, according to one embodiment. In some embodiments, the system of FIG. 5 may use a function h(x, y) that is real-valued but cannot be directly synthesized on the kernel plane. In such embodiments, the system may express the function h(x, y) as the difference of two other kernels h(x, y)=a(x, y)−b(x, y), where a(x, y) and b(x, y) are the kernels formed by two sets of modulations of Lorentzian elements. As illustrated, the four measurements of the intensity include both combinations of the object plane with phases ϕᵣ(x, y) and π−ϕᵣ(x , y) and both kernels a(x, y) and b(x, y) to find the convolution g(x, y).

A general real-valued function h(x, y) may not directly be synthesized from Lorentzian elements in the kernel plane since the Fourier transform of a real function has Hermitian symmetry. Lorentzian elements can be Hermitian symmetric reflected over the origin of the kernel plane; however, the circle of available polarizabilities does not generally represent all needed polarizabilities at every frequency. To find a combination of Lorentzian convolutions that can perform the convolution, the real-valued function h(x, y) is separated into two functions: an even function hₑ(x, y) and an odd function hₒ(x, y) which add to h(x, y). The Fourier transform of hₑ(x, y) is both purely real-valued and even, while the Fourier transform of hₒ(x, y) is purely imaginary and odd. Accordingly, the Fourier transform of ihₒ(x, y) is real-valued and odd. The difference between two Lorentzians is represented as a real-valued function, as shown in FIG. 8.

According to various embodiments, the system may use the real-valued function representing the difference between two Lorentzians to find f(x, y)*hₑ(x, y) and f(x, y)*hₒ(x, y), and the results may be added together to get f(x, y)*[hₑ(x, y)+hₒ(x, y)]=f(x, y)*h(x, y). As such, the systems and methods described herein utilize a 4F optical system with tunable metamaterial elements representable as Lorentzians at the object plane and the Fourier plane to calculate arbitrary real convolutions as follows:

Given a kernel function with the following definition of its Fourier Transform:

\tilde{h}(v_{x,} v_{y})=∫∫h(x, y)exp[i2π(vₓx+v_{y}y)dxdy]

\tilde{h}(−v_{x,} −V_{y})* =∫∫h(x, y)*exp[i2π(vₓx+v_{y}y)]dxdy

The real-valued kernel implies:

h(x, y)=h(x, y)*

\tilde{h}(v_{x,} v_{y)}=\tilde{h}(−v_{x,} −v−v_{x,} −V_{y}_{_{y}})*

A Lorentzian kernel can be expressed as the sum:

\tilde{h}(v_{x,} v_{y})=γh+αₕ exp i∅ₕ(V_{x,} v_{y})

This Lorentzian represents the Fourier transform of a real-valued function, such that:

∅ₕ(v_{x,} v_{y})=−∅ₕ(−v_{x,} −v_{y})

Each real-valued kernel can be decomposed into even and odd components, expressible as:

$$h ( x , y ) = {h}_{e} ( x , y ) + {h}_{o} ( x , y ) \\ {h}_{e} ( x , y ) = \frac{1}{2} [ h ( x , y ) + h ( - x , - y ) ] \\ {h}_{o} ( x , y ) = \frac{1}{2} h [ ( x , y ) - h ( - x , - y ) ]$$

The following symmetries exist for the Fourier transforms thereof:

\tilde{h}(v_{x,} v_{y})=\tilde{h}(−vₓ, −v_{y})*

\tilde{h}ᵣ(v_{x,} v_{y})=hᵣ (−vₓ, −v_{y})*

i\tilde{h}ᵢ(v_{x,} v_{y})=ihᵣ (−v_{x,} −v_{y})*

Convolutions may be performed separately with the even and odd parts of the kernel using the method previously described to convolve a real function with another real function represented by the difference between two complex functions. For the real part, the Fourier transform of the even part of the complex function is expressed as:

$${h}_{e} ( x , y ) = \frac{h ( x , y ) + h ( - x , - y )}{2}$$

such that:

$${\tilde{h}}_{r} ( {v}_{x} , {v}_{y} ) = 2 {α}_{h} cos {∅}_{e} ( {v}_{x} , {v}_{y} ) = \int \int {h}_{e} ( x , y ) exp [ i 2 π ( {v}_{x} x + {v}_{y} y ) ] dxdy$$

The Fourier transform is separated into the difference of two Lorentzian functions, such that:

\tilde{h}ᵣ(v_{x,} v_{y})=ãᵣ(vₓ, v_{y})−\tilde{b}ᵣ(vₓ, v_{y})

ãᵣ(vₓ, v_{y})=γₕ+αₕ exp i∅ₑ^{a}(vₓ, v_{y})

\tilde{b}ᵣ(vₓ, v_{y})=γₕ+α_{h exp i}(π−∅ₑ^{b}(vₓ, v_{y}))

The system may then evaluate the convolution of a constant term with each of the two Lorentzians, expressible as:

γ_{f}*h(x, y)=γ_{f∫∫h}(x, y) dxdy=h(0, 0)

γ_{f}*h(x, y)=γ_{f}ãᵣ(0, 0)=γ_{f}ãᵣ+γ_{f}αₕ exp[i∅ₑ^{a}(0, 0)]

γ_{f}*bᵣ(x, y)=γ_{f}\tilde{b}ᵣ(0, 0)=γ_{f}γₕ−γ_{f}αₕ exp[−i∅ₑ^{b}(0, 0)]

The system may perform the convolution while passing through a zero frequency with the two functions having the same phase, such that:

∅ₑ^{a}(0, 0)=0

∅ₒ^{b}(0, 0)=π

∅ₑ^{a}(vₓ, v_{y})=∅ₑ^{b}(vₓ, v_{y})=∅ₑ(vₓ, v_{y}) for vₓv_{y}≠0

The system may evaluate the constant part of the convolution as follows:

γ_{f}*aᵣ(x, y)=γ_{f}*bᵣ(x, y)=γ_{f}(γₕ+αₕ)

The system may also take the Fourier transform of the odd part of the complex function as:

$${h}_{o} ( x , y ) = \frac{h ( x , y ) - h ( - x , - y )}{2}$$

such that:

i\tilde{h}ᵢ(vₓ, v_{y})=2iαₕ sin ∅ₑ(vₓ, v_{y})=∫∫hₒ(x, y)exp [i2π(vₓx+v_{y}y)]dxdy

Again, the system may separate the Fourier transform of the odd part of the complex function into the difference between two Lorentzian functions, expressible as:

$${\tilde{h}}_{i} ( {v}_{x} , {v}_{y} ) = {\tilde{a}}_{i} ( {v}_{x} , {v}_{y} ) - {\tilde{b}}_{i} ( {v}_{x} , {v}_{y} ) \\ {\tilde{a}}_{i} ( {v}_{x} , {v}_{y} ) = {γ}_{h} + {α}_{h} exp [ \frac{π}{2} - i {∅}_{o}^{a} ( {v}_{x} , {v}_{y} ) ] \\ {\tilde{b}}_{i} ( {v}_{x} , {v}_{y} ) = {γ}_{h} + {α}_{h} exp [ \frac{π}{2} + i {∅}_{o}^{b} ( {v}_{x} , {v}_{y} ) ]$$

The system may then evaluate the convolution of the constant term with each of the two Lorentzians, expressible as:

γ_{f}*h(x, y)=γ_{f}∫∫h(x, y)dxdy=h(0, 0)

γ_{f}*aᵢ(x, y)=γ_{f}ãᵢ(0, 0)=γ_{f}γₕ+γαₕ exp[i₂^{π}−i∅ₒ^{a}(0, 0)]

γ_{f}*bᵢ(x, y)=γ_{f}bᵢ(0, 0)=γ_{f}γₕ+γαₕ exp[i₂^{π}+i∅ₒ^{b}(0, 0)]

The system may perform the convolution of the odd part of the complex function while passing through the zero frequency with the two functions having the same phase, such that:

$${∅}_{o}^{a} ( 0 , 0 ) = - {∅}_{o}^{b} ( 0 , 0 ) = \frac{π}{2} \\ {∅}_{o}^{a} ( {v}_{x} , {v}_{y} ) = {∅}_{o}^{b} ( {v}_{x} , {v}_{y} ) = {∅}_{o} ( {v}_{x} , {v}_{y} ) for {v}_{x} {v}_{y} \neq 0$$

The system may evaluate the constant part of the convolution as follows:

γ_{f}*aᵢ(x, y)=γ_{f}*bᵢ(x, y)=γ_{f}(γₕ+αₕ)

Following separate treatment of the even and odd parts of the complex function, the system may perform the entire real convolution between two real functions, which is given by:

g(x, y)=f(x, y)*h(x, y)

The function f (x, y) can be represented by a difference of two Lorentzians:

f(x, y)=f⁺(x, y)−f⁻(x, y)
with either a cosine phase represented as:

f⁺(x, y)=γ_{f}+α_{f} exp(i∅ᵣ)

f⁻(x, y)=γ_{f}+α_{f} exp(i[π−∅ᵣ])

f(x, y)=2 α_{f} sin ∅ᵢ
or a sine phase represented as:

$${f}^{+} ( x , y ) = {γ}_{f} + {α}_{f} exp [ i \frac{π}{2} - i {∅}_{i} ] \\ {f}^{-} ( x , y ) = {γ}_{f} + {α}_{f} exp [ i \frac{π}{2} + i {∅}_{i} ]$$

The system may decompose the kernel into odd and even parts such that:

\tilde{h}ᵣ(vₓ, v_{y})=ãᵣ(vₓ, v_{y})=\tilde{b}ᵣ(vₓ, v_{y})

\tilde{h}ᵢ(vₓ, v_{y})=ãᵢ(vₓ, v_{y})=\tilde{b}ᵢ(vₓ, v_{y})

The system may obtain four intensity measurements for the even component of the kernel function:

Iᵣ=|f⁺(x, y)*aᵣ(x·y)|²−|f⁻(x, y)*aᵣ(x, y)|²−|f⁺(x, y)*bᵣ(x, y)|²+|f⁻(x, y)*bᵣ(x, y)|²=2α_{fγf}(γₕ+αₕ)[f(x, y)*hₑ(x, y)]
and four intensity measurements for the odd component of the kernel function:

Iᵢ=|f⁺(x, y)*aᵢ(x·y)|²−|f⁻(x, y)*aᵢ(x, y)|²−|f⁺(x, y)*bᵢ(x, y)|²+|f⁻(x, y)*bᵢ(x, y)|²=2α_{fγf}(γₕ+αₕ)[f(x, y)*hₒ(x, y)]

The system may then sum the even and odd parts as:

I=Iᵣ₊Iᵢ=2α_{fγf}(γₕ+αₕ)[f(x, y)*(hₑ(x, y)+hₒ(x, y))]=2α_{fγf}(γₕ+αₕ)f(x, y)*h(x, y)

In various embodiments, the systems and methods described herein may utilize traditional spatial light modulators. In other embodiments, a system may utilize dynamically tunable metasurfaces instead of spatial light modulators. In various embodiments described herein, the spatial light modulators may be embodied as tunable optical metasurfaces, digital micromirror devices, and/or liquid crystal on silicon devices.

This disclosure has been made with reference to various exemplary embodiments, including the best mode. However, those skilled in the art will recognize that changes and modifications may be made to the exemplary embodiments without departing from the scope of the present disclosure. While the principles of this disclosure have been shown in various embodiments, many modifications of structure, arrangements, proportions, elements, materials, and components may be adapted for a specific environment and/or operating requirements without departing from the principles and scope of this disclosure. These and other changes or modifications are intended to be included within the scope of the present disclosure.

This disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element.

What is claimed is:

1. A system to perform a convolution operation using optical fields, comprising:
an object plane modulator to transmit a coherent optical field encoded with:
(i) an input object field, and
(ii) a constant field;
a first optical assembly to implement a first optical Fourier transform of the encoded coherent optical field;
a kernel plane modulator to modulate a kernel pattern onto the encoded coherent optical field;
a second optical assembly to implement a second Fourier transform of the encoded coherent optical field modulated with the kernel pattern to generate an output optical field that includes a convolution of the input object field; and
an optical detector to detect intensities of the output optical field,
wherein the object plane modulator is configured to vary a phase between the input object field and the constant field for each convolution operation.

2. The system of claim 1, wherein the object plane modulator comprises a first spatial light modulator.

3. The system of claim 1, further comprising:
a digital processing subsystem to perform at least one arithmetic operation on the detected intensities of the output optical field to generate digital data representing the convolution of the input object field.

4. The system of claim 3, wherein the object plane modulator is configured to vary the phase between the input object field and the constant field for each convolution operation between two phase differentials that are pi radians apart.

5. The system of claim 3, wherein the object plane modulator is configured to vary the phase between the input object field and the constant field for each convolution operation between phase states that are symmetrically located relative to a fixed phase.

6. The system of claim 3, wherein the object plane modulator comprises a first tunable optical metasurface.

7. The system of claim 3, wherein the kernel plane modulator comprises a second spatial light modulator.

8. The system of claim 7, wherein the second spatial light modulator comprises a second tunable optical metasurface.

9. A method to implement an optical convolution using optical fields, comprising:
generating, using an object plane modulator, a sequence of coherent optical fields that are each encoded with a superimposed object field and a constant function field, including a first Fourier-transformed sequence of coherent optical fields, wherein the constant function field is phase-shifted with respect to the superimposed object field for each successive coherent optical field generated in the sequence of coherent optical fields;
performing, via a first lens system, a first Fourier transform of each coherent optical field in the generated sequence of coherent optical fields;
encoding, via a kernel plane modulator, a kernel function onto the first Fourier-transformed sequence of coherent optical fields;
performing, via a second lens system, a second Fourier transform of each of the sequence of coherent optical fields to generate a sequence of convolved optical fields; and
detecting, via an optical detection subsystem, intensity values of each of the sequence of convolved optical fields.

10. The method of claim 9, wherein the sequence of coherent optical fields comprises:
a first coherent optical field encoded with the superimposed object field and the constant function field at a first phase-shift value; and
a second coherent optical field encoded with the superimposed object field and the constant function field at a second phase-shift value that is pi radians apart from the first phase-shift value.

11. The method of claim 9, wherein the sequence of coherent optical fields comprises:
a first coherent optical field encoded with the superimposed object field and the constant function field at a first phase-shift value, and
a second coherent optical field encoded with the superimposed object field and the constant function field at a second phase-shift value,
wherein the first and second phase-shift values are symmetrically located relative to a fixed phase value.

12. The method of claim 9, wherein the object plane modulator comprises a first spatial light modulator.

13. The method of claim 12, wherein the first spatial light modulator comprises a first tunable optical metasurface.

14. The method of claim 13, wherein the kernel modulator comprises a second spatial light modulator.

15. The method of claim 14, wherein the second spatial light modulator comprises a second tunable optical metasurface.

16. The method of claim 11, further comprising:
generating, via a digital processing subsystem, digital data representing the convolution of the object field based on at least one arithmetic operation on the detected intensity values of each of the sequence of convolved optical fields.

17. An optical computing system, comprising:
an electronic input subsystem to receive input digital data;
a first spatial light modulator to transmit a sequence of coherent optical fields, wherein each of the sequence of coherent optical fields is encoded with the input digital data and a phase-shifted variation of a reference field;
an optical subsystem to:
implement a first Fourier transform of each of the sequence of coherent optical fields to form a sequence of Fourier-transformed coherent optical fields,
modulate kernel data onto each of the sequence of Fourier-transformed coherent optical fields, and
implement a second Fourier transform of each of the sequence of Fourier-transformed coherent optical fields modulated with the kernel data to generate a sequence of convolved output optical fields; and
an optical detection subsystem to:
detect intensity values of each of the sequence of convolved output optical fields, and
generate digital data representing the convolution of the input digital data and the kernel data.

18. The system of claim 17, wherein the first spatial light modulator comprises a first tunable optical metasurface, and
wherein the optical subsystem modulates the kernel data onto each of the sequence of Fourier-transformed coherent optical fields via a second tunable optical metasurface.

19. The system of claim 18, wherein the first spatial light modulator is configured to vary the phase of the reference field in each successive coherent optical field in the sequence of Fourier-transformed coherent optical fields by pi radians.

20. The system of claim 18, wherein the first spatial light modulator is configured to vary the phase of the reference field in each successive coherent optical field in the sequence of Fourier-transformed coherent optical fields by a phase value that is symmetrically located relative to a fixed phase.
